(19) United States
(12) Patent Application Publication
(10) Pub. No.: US 2008/0197670 A1
(43) Pub. Date: Aug. 21, 2008

(54) Vehicle Component and Method For Making a Vehicle Component

(75) Inventors: Michael J. VonHoltz, Holland, MI (US); Jeffrey A. Cussimanio, Holland, MI (US); Chad M. Baumann, Zeeland, MI (US)

Correspondence Address: FOLEY AND LARDNER LLP;SUITE 500, 3000 K STREET NW, WASHINGTON, DC, 20007, US

(73) Assignee: Johnson Controls Technology Company, Holland, MI (US)

(21) Appl. No.: 11/629,378

(22) PCT Filed: Jun. 14, 2005
(86) PCT No.: PCT/US2005/020715

§ 371 Date: Dec. 14, 2007

Related U.S. Application Data
(60) Provisional application No. 60/579,734, filed on Jun. 15, 2004.

(51) Int. Cl. B62D 29/04; B29C 45/14

(52) U.S. Cl. 296/181.2; 264/278; 264/266

(57) ABSTRACT

A trim panel includes a body portion and an extension (110). The extension is provided at a periphery of the body portion for securing the trim panel to the vehicle. The extension is formed of a cover stock (104) material and a substrate (102). The body portion and the extension (110) are formed during the same molding operation. According to one exemplary embodiment, the cover stock material (104) is positioned into a mold (200), the mold (200) is reconfigured to bend an edge of the cover stock material (104) inward, and a resin is injected into the mold (200) to form the substrate.

### CROSS-REFERENCE TO RELATED PATENT APPLICATIONS

The present application claims priority to U.S. Provisional Patent Application No. 60/579,734, filed on Jun. 15, 2004 and titled METHOD FOR MAKING A VEHICLE COMPONENT, the full disclosure of which is hereby incorporated herein by reference.

### BACKGROUND

The present inventions relate generally to the field of components such as panels or other structures for use in vehicles (e.g., automobiles such as cars, trucks, and the like; airplanes, boats, etc.). More specifically, the present inventions relate to methods for making interior panels or structures for vehicles or other applications.

Interior vehicle components such as panels (e.g., instrument panels, door panels, etc.) conventionally include a substrate made of a relatively rigid material and an outer surface or skin. The outer surface or skin is sometimes referred to as “cover stock.” For example, the surface of a door panel facing the passenger compartment (sometimes referred to as the “A” surface of the panel) may include a fabric, leather, polymeric, or other type of material provided thereon. Such surface material may be provided in any of a wide variety of colors, textures, and/or designs.

In certain applications (e.g., door panel applications), it may be desirable to have an extension in the form of a flange or overhang for enabling coupling of the component to other vehicle components. For example, it may be desirable to mold a flange as part of a door panel along a top or upper portion thereof to allow the top or upper portion of the door panel to engage a feature provided in a door assembly. In this manner, the interior door panel may be relatively securely coupled to the door assembly.

In conventional applications, the flange or overhang is formed in a secondary operation subsequent to molding the component. That is, a component is made (e.g., by injection molding) after which a flange is attached to the component in a secondary operation or, e.g., by cutting and bending a portion of the component to form the flange.

There is a need to provide a method for making or producing components such as panels or other structures for use in vehicles that include one or more extensions in the form of flanges or overhangs. There is also a need to provide a method for making or producing such components in a relatively quick and efficient manner. There is also a need to provide a method for making or producing such components such that the extension includes a cover stock provided thereon such that the extension is covered by the cover stock at the “A” surface of the component and the substrate forming the flange is not visible to passengers in a passenger compartment or through a window adjacent the flange. It would be desirable to provide a method for making or producing a vehicle component including one or more of these or other advantageous features.

### SUMMARY

An exemplary embodiment of the invention relates to a method of forming a component for a vehicle. The method includes providing a cover stock material in a mold having a first mold section, a second mold section, and a third mold section, and moving the first mold section and the third mold section toward the second mold section. The third mold section moves in a direction substantially transverse to the movement of the first mold section such that the third mold section engages and directs an end portion of the cover stock material to bend inward toward a first surface of the cover stock material. The method further includes forming a substrate by injecting a resin into the mold adjacent to the first surface of the cover stock material. A molded-in extension is formed comprising the substrate and the end portion of the cover stock.

Another exemplary embodiment of the invention relates to a trim panel for use in a vehicle. The trim panel includes a one-piece molded member having a body portion and an extension. The extension is provided at a periphery of the body portion for securing the trim panel to the vehicle. The extension is formed of a cover stock material and a substrate. The body portion and the extension are formed during the same molding operation wherein the cover stock material is positioned into a mold, the mold is reconfigured to bend an edge of the cover stock material inward, and a resin is injected into the mold to form the substrate.

Another exemplary embodiment of the invention relates to a method of forming a component for a vehicle. The method includes forming a substrate by injecting a resin into a mold having a first mold section and a second mold section. The substrate has an extension in an extended position. The method further includes providing a boundary between the extension and a body portion of the substrate for assisting in moving the extension between the extended position and a retracted position, subjecting the substrate to localized heating and bending the extension about the boundary until the retracted position is achieved. The extension provides a mechanism for securing the component to the vehicle.

### BRIEF DESCRIPTION OF THE DRAWINGS

FIG. 1 is a plan view of a front surface of a vehicle component in the form of an interior door panel according to an exemplary embodiment.

FIG. 2 is a plan view of a rear surface of the vehicle component shown in FIG. 1 according to an exemplary embodiment.

FIG. 2a is a cross-sectional view of a portion of the vehicle component shown in FIG. 2 taken across line 2a-2a at the location of an extension according to an exemplary embodiment.

FIG. 3 is a cross-sectional view of an injection molding system shown in an open position according to an exemplary embodiment.

FIG. 4 is a cross-sectional view of the injection molding system of FIG. 3 shown in an intermediate position according to an exemplary embodiment.

FIG. 5 is a cross-sectional view of the injection molding system of FIG. 3 shown in a closed position according to an exemplary embodiment.

FIG. 6 is a perspective view of a portion of a vehicle component in the form of an interior door panel according to another exemplary embodiment.

FIG. 6a is a cross-sectional view of a portion of the vehicle component shown in FIG. 6 taken across line 6a-6a at the location of an extension according to an exemplary embodiment.

FIG. 7 is a perspective view of the vehicle component shown in FIG. 6 showing the extension in a second position according to an exemplary embodiment.

### DETAILED DESCRIPTION

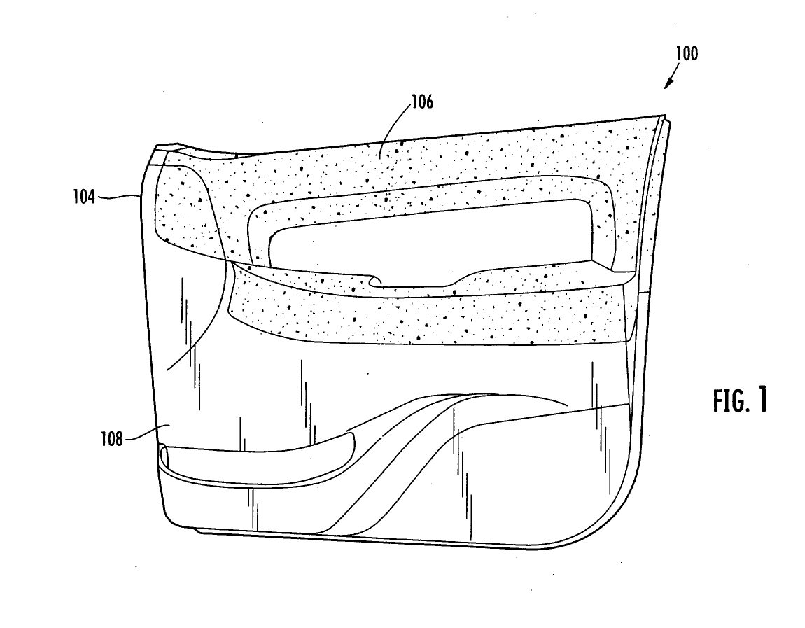

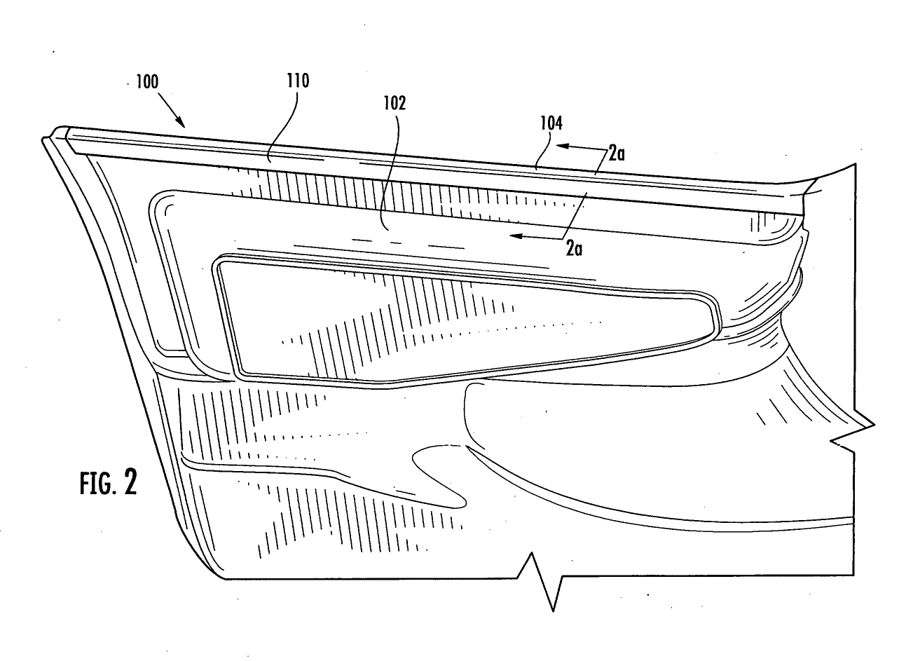

Referring to FIGS. 1 and 2, a front portion and a rear portion of a component 100 for use in an interior of a vehicle are shown respectively. Component 100 includes a substrate 102 having a material 104 (e.g., a cover stock material) applied thereto.

Referring to FIG. 1 in particular, material 104 covers at least a portion of a front or “A” surface of component 100 and may be selected from any of a variety of materials, including fabric, leather, a polymeric material (e.g., vinyl), or a variety of other materials. Component 100 may also utilize more than one different type of material on the front surface thereof. Material 104 is intended to be provided facing the passenger compartment, and therefore may include any of a number of designs or patterns provided thereon for enhanced aesthetic appeal. Material 104 is shown as including two separate types of cover stock material provided thereon (shown as a first portion 106 and a second portion 108). According to various alternative embodiments, material 104 may include any number of cover stock materials (e.g., one, three, etc.).

Referring to FIG. 2 in particular, substrate 102 is formed of a relatively rigid material such as a relatively rigid plastic material, a metal, or any other rigid material conventionally used to form substrates for interior vehicle components. For example, substrate 102 may be made of polypropylene or a thermoplastic olefin according to an exemplary embodiment. According to other exemplary embodiments substrate 102 may be made of an acrylonitrile butadiene styrene (ABS) polymer or a polycarbonate/acrylonitrile butadiene styrene (PC/ABS) polymer. Any of a variety of other materials may also be used to form substrate 102.

As illustrated in FIGS. 2 and 2a, component 100 includes an extension or protrusion 110 in the form of a flange or overhang according to an exemplary embodiment. Extension 110 is sometimes referred to as a “downturn flange.” As shown in FIGS. 2 and 2a, extension 110 includes both a portion of substrate 102 and material 104. Extension 110 is intended to act as a mechanism for securing component 102 other vehicle components. For example, extension 110 may be used to engage a portion of a door assembly (e.g., extension 110 may engage a feature (not shown) provided in a sheet steel portion of a door assembly, etc.). In conventional vehicle applications, a portion of extension 110 may be visible from the interior of the vehicle passenger compartment. By providing an extension 110 that includes material 104 provided thereon, substrate 102 is not visible to passengers sitting adjacent component 100 in a vehicle.

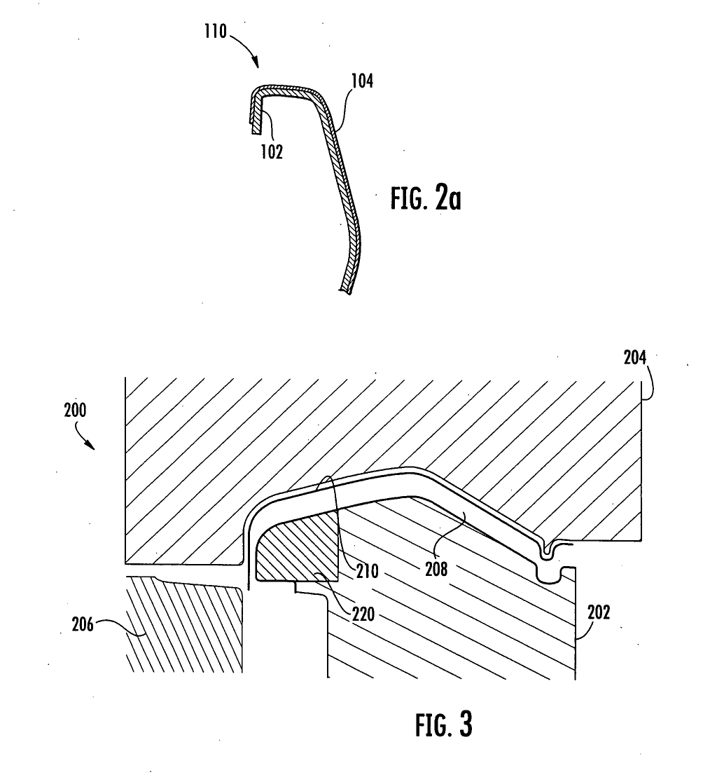

FIGS. 3-5 illustrate the formation of a vehicle component similar to that shown in FIG. 1 according to an exemplary embodiment. FIGS. 3-5 show the formation of an illustrative exemplary embodiment of a vehicle component, and one of ordinary skill in the art will recognize that the particular size, shape, and configuration of the vehicle component may vary according to other exemplary embodiments.

FIG. 3 shows a mold 200 having a stationary portion 202 and a movable portion 204. Mold 200 also includes a slide 206 and a lifter mechanism 220, the function of which will be described below.

As shown in FIG. 3, a piece of material 210 (i.e., a cover stock material such as cloth, fabric, leather, a polymeric material, etc.) is provided within a chamber 208 of mold 200. Material 210 may be relatively flexible such that material 210 may be formed into a desired shape in the mold (e.g., to take the shape of a panel such as a door panel for a vehicle).

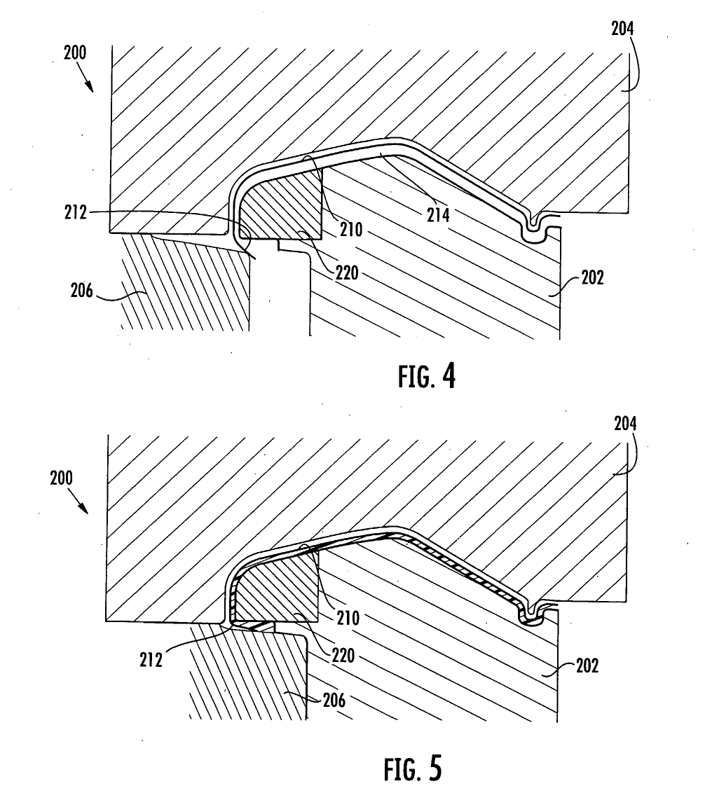

FIGS. 4-5 illustrate the action of mold 200 during a forming operation according to an exemplary embodiment. As shown in FIG. 4, movable portion 204 of mold 200 moves toward stationary portion 202 and lifter mechanism 220 of mold 200 during closure of mold 200 around material 210. As movable portion 204 moves toward stationary portion 202 and lifter mechanism 220, an end portion 212 of material 210 engages a portion of slide 206 such that a portion of material 210 begins to bend or flex. The flexure of end portion 212 ultimately may be used to form an extension in the form of a flange or overhang for the component being manufactured, as will be described below.

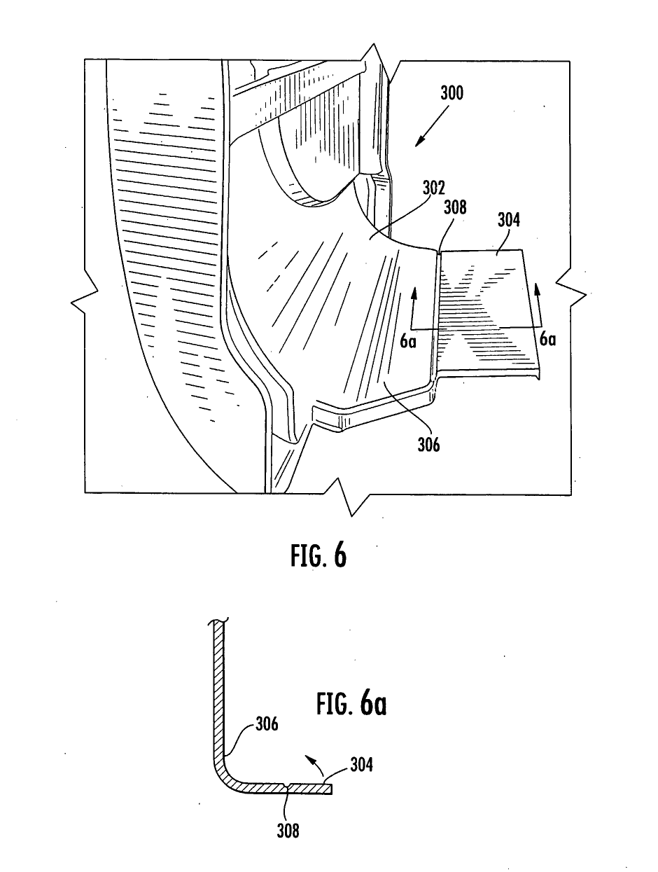

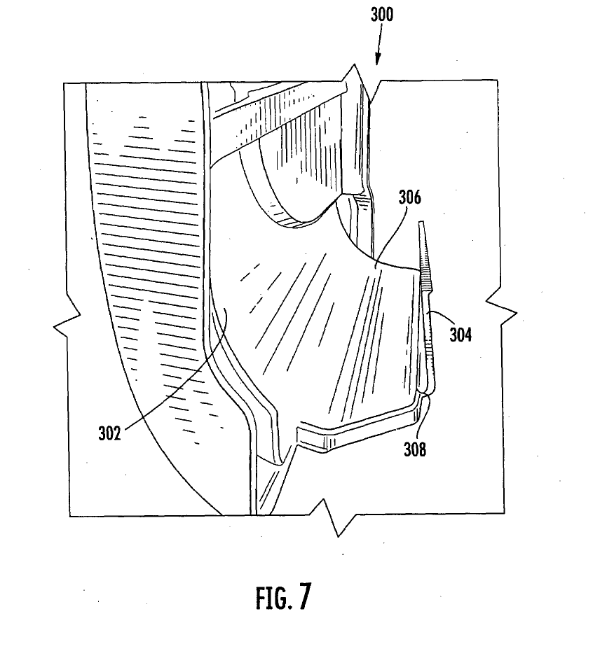

As movable portion 204 of mold 200 continues to move toward stationary portion 202 of mold 200, a cavity or space 214 between material 210 and stationary portion 202 decreases in size, while end portion 212 of material 210 continues to bend or flex. During the closure of mold 200, slide 206 moves to assist material 210 in pending or flexing. Thus, as shown in FIGS. 6C and 6D, slide 206 moves from left to right as illustrated, which assists in the bending or flexing of material 210 during the forming operation.

FIG. 5 illustrates the final position of the mold 200 according to an exemplary embodiment. As shown, end portion 212 of material 210 is bent or flexed inward to form a portion of an extension or flange. Slide 206 is moved to the right such that slide 206 engages stationary portion 202 of mold 200. Subsequent to closure of mold 200 as illustrated in FIG. 5, a polymeric material such as polypropylene or a thermoplastic olefin may be injected into mold 200 such that it fills the cavity or space 214 between material 210 and stationary portion 202 and lifter mechanism 220 to form a substrate to which material 210 is coupled (such as, e.g., substrate 102 shown in FIG. 2). Material 210 may form a physical and/or chemical bond with the injected polymeric material such that the material and substrate are relatively securely bonded together. Thus, the extension in the form of a flange or overhang is formed on the surfaces of the lifter mechanism. Subsequent to formation of the substrate in the injection molding operation, the lifter mechanism retracts from the component at an angle of approximately 5 degrees while the other components of the ejector system retract at an angle of zero degrees (i.e., perpendicular to the tool). The lifter mechanism thus pulls from the molded extension due to the 5 degree angle. According to another exemplary embodiment, the lifter mechanism may pull from the molded extension at a different angle (e.g., greater or less than approximately 5 degrees).

The result of this injection molding process is the formation of a component such as a panel (e.g., a door panel) that includes an extension in the form of a flange or overhang such as that shown in FIGS. 2 and 2a. Excess material or flashing may remain subsequent to the formation of extension 110. Any such excess material may be removed subsequent to the injection molding process, for example, by cutting or trimming the excess material from the area of the extension.

One advantageous feature of producing a vehicle component using a method such as that shown in FIGS. 3-5 is that it is relatively simple and efficient to form an extension in the form of a flange or overhang using a single piece of manufacturing equipment (e.g., injection molding equipment configured as described above). The requirement of secondary bending operations (i.e., to bend the substrate to produce the extension) is eliminated using such an operation. Further, the method described with respect to FIGS. 3-5 allows the manufacture of vehicle components that have a cover stock material (e.g., fabric, leather, a polymeric material, etc.) provided over an extension such as a flange such that the substrate-portion of the extension is not visible to passengers in a vehicle or through a window adjacent the extension.

While FIGS. 1-5 show a vehicle component formed in a molding operation in which an extension in the form of a flange or overhang are formed in an injection molding operation according to an exemplary embodiment, FIGS. 6-7 illustrate the formation of an extension in the form of a flange or overhang according to another exemplary embodiment. FIGS. 6-7 relate generally to the formation of an extension using a secondary bending process subsequent to formation of the vehicle component. The component formed may include a cover stock material provided on the extension prior to or after the secondary bending process is completed.

As shown in FIGS. 6-7, a vehicle component 300 in the form of a door panel is intended to be provided in a bending device or mechanism. While only a substrate 302 of component 300 is shown in FIGS. 6-8, component 300 may also include a cover stock material such as that described above provided on the front or “A” surface thereof. Substrate 302 may be made of any of the substrate materials described above. According to an exemplary embodiment, substrate 302 is made of a polypropylene or another thermoplastic olefin material. According to other exemplary embodiments, the substrate may be made of an ABS or PC/ABS polymer.

Component 300 includes a portion 304 that extends away from a body 306 of component 300 and which is separated from body 306 by a boundary 308 such as an indentation or channel molded into component 300. Boundary 308 is intended to provide a location about which portion 304 may rotate during the formation of an extension in the form of a flange or overhang. Component 300 is formed in an injection molding process according to an exemplary embodiment. The mold used for the injection molding process includes a feature which forms boundary 308. While boundary 308 is shown as a continuous channel formed along the edge of portion 304, in a variety of other configurations for boundary 308 may be used. For example, a discontinuous channel may be formed along and edge of portion 304 between end portion 304 and body 306. A number of different configurations which may be used to form a boundary between a portion of the component and the body of the component. For example, according to an exemplary embodiment, a combination of ribs and channels may be used for the boundary.

According to an exemplary embodiment, a heating device (not shown) is configured to direct infrared radiation toward component 300 to heat boundary 308. According to an exemplary embodiment, the heating device is an Infrastake device available from Extol, Inc. of Zeeland, Mich. According to other exemplary embodiments, other types of heating devices may be used to heat the material adjacent the boundary (e.g., a heated rod or device may be provided adjacent boundary 308 to heat the material in the region of boundary 308 to allow bending/flexure of the component about the boundary; such heated rods act to heat the component using convection or radiation due to the proximity of the rods to the component). According to other exemplary embodiments, the boundary may be heated using other types of radiation (e.g., microwave radiation.

Heating the material in the region of boundary 308 changes the rigidity of the material and allows the relatively easy flexure or bending of portion 304 to form an extension in the form of a flange or overhang. For example, at least a portion of the material in the region of the boundary may melt to allow relatively easy flexure of the material about the boundary. The temperature utilized may depend on a variety of factors, such as the type of polymer utilized. Such temperature should be selected such that it heats the material to a sufficient degree so as to allow for relatively easy flexibility of the portion about the boundary.

During operation of the heating device, the material of boundary 308 and regions adjacent boundary 308 are heated. According to an exemplary embodiment, the distance between the lamp of the heating device and the surface of the component is approximately 11 millimeters (mm) and the component is heated for a period of between approximately 10 and 20 seconds, followed by a hold time of approximately 20 seconds (i.e., portion 304 is rotated about boundary 308 and held in the desired position for approximately 20 seconds subsequent to removal of the heating device) such that the portion 304 remains in the rotated position.

By directing the infrared radiation at the boundary (which is provided in the form of an indentation or channel such that the material is thinner in the boundary than in the surrounding material), the effects of the heating on the substrate are localized such that only the immediate area is affected.

FIG. 7 shows portion 304 having been bent toward body 306 of component 300 subsequent to removal of the heating device. Heating of the region around boundary 308 allows bending to proceed without damaging component 300 in a manner which limits the flexure of component 300 to boundary 308.

FIGS. 6-7 show portion 304 in the form of an extension that is formed such that there is a relatively smooth transition between body 306 of component 300 and portion 304 (e.g., there is substantially no discontinuity at point 320 where the edge of portion 304 joins body 306). According to another exemplary embodiment, a portion of each of the ends of portion 304 may be removed such that there is a transition region between body 306 and portion 304 (e.g., there is a discontinuity between portion 304 and body 306 such that portion 304 does not extend the entire width of body 306 at the point of connection between portion 304 and body 306). For example, portion 304 may be molded such that its edges are approximately 0.5 inches inward from body 306. According to another exemplary embodiment, approximately 0.5 inches of each of the edges of portion 304 are removed subsequent to molding. According to another exemplary embodiment, the distance may vary (e.g., may be greater or less than 0.5 inches). One advantageous feature of providing a discontinuity with portion 304 is that more uniform heating of the component may be obtained to localize the effects of the heating to a greater degree than with respect to the embodiment shown in FIGS. 6-7. It should be emphasized that either embodiment may be used depending on the particular application involved and other considerations (e.g., tolerances on parts, materials used, etc.).

One advantageous feature of utilizing a post-molding process such as that described with respect to FIGS. 6-7 is that there is no need to utilize an injection molding machine having the various required components as described above with respect to FIGS. 1-5. For example, there is no need for a slide such as slide 206 to bend a portion of the component prior to injecting the material to form the substrate. Another advantageous feature of using a heating device that directs infrared radiation to a localized region of the component is that the heating occurs at a relatively rapid pace such that manufacturing processes may be performed in a relatively quick and efficient manner. Additionally, damage to surrounding regions that may occur in other post-mold flange formation may be minimized. Ribs, bosses, or other features may also be added to or molded into the component prior to the heating operation to further localize the bending location for the component.

As one of skill in the art will appreciate from the foregoing disclosure, the present application relates to a number of ways of forming a component for a vehicle such as a panel (e.g., a door panel) that includes an extension in the form of a flange or overhang (e.g., a downturn flange). One nonexclusive exemplary embodiment includes providing a cover stock material (e.g., leather, cloth, fabric, a polymeric material, etc.) in a mold (e.g., an injection mold) and closing the mold such that a portion of the cover stock material is bent or flexed to form an exterior portion of the extension. The mold includes a stationary portion or surface, a moving portion or surface, and a slide. The moving portion of the mold moves toward the stationary portion while the slide moves in a direction transverse to that of the movement of the moving portion of the mold such that it engages and directs a portion of the cover stock material to bend in the direction of the motion of the slide. After the mold is closed to its final position, a polymeric material is injected into the mold adjacent the cover stock material (e.g., in a cavity or space between the cover stock material and the stationary portion of the mold) to form a substrate for the component. In this manner, a molded-in flange or overhang is formed in the component having a cover stock material applied to the flange or overhang.

According to another nonexclusive exemplary embodiment, a post-molding operation in utilized in which a substrate (either by itself or having a cover stock material bonded or coupled thereto) is subjected to localized heating (e.g., using an infrared radiation heating device). The substrate (and any attached cover stock material) is bent around the heated region due to melting of the substrate material in this region. To assist in the bending process, the region to be heated may include a molded in or post-molded feature such as a boundary in the form of an indentation or channel. In this manner, the physical dimensions of the region to be heated by the heating device is different from the surrounding material (e.g., it is thinner due to the formation of a channel at the boundary region) such that the heating may be accomplished more quickly and/or may be accomplished in a manner that does not substantially affect regions of the component away from the boundary. After the portion of the substrate is heated, a portion of the substrate is bent or flexed to form an extension such as a flange or overhang. Such bending may utilize automated equipment that moves or forces a portion of the substrate to rotate about the heated region or may be accomplished manually.

The construction and arrangement of the elements of the vehicle component as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements, the position of elements may be reversed or otherwise varied, and the nature or number of discrete elements or positions may be altered or varied (e.g., more than one flange may be created in a single component (e.g., a door panel may include multiple flanges formed by the methods described herein). It should be noted that the elements and/or assemblies of the system may be constructed from any of a wide variety of materials that provide sufficient strength or durability, including any of a wide variety of moldable plastic materials (such as high-impact plastic) in any of a wide variety of colors, textures and combinations. Components such as those shown herein may be used in non-vehicle applications as well, including but not limited to furniture such as chairs, desks, benches, and other furniture items. Other substitutions, modifications, changes and omissions may be made in the design, operating conditions and arrangement of the preferred and other exemplary embodiments without departing from the scope of the present inventions.

1. A method of forming a component for a vehicle, the method comprising:
providing a cover stock material in a mold, the mold having a first mold section, a second mold section, and a third mold section;
moving the first mold section and the third mold section toward the second mold section, the third mold section moving in a direction substantially transverse to the movement of the first mold section such that the third mold section engages and directs an end portion of the cover stock material to bend inward toward a first surface of the cover stock material;
forming a body portion by injecting a resin into the mold adjacent to the first surface of the cover stock material to provide a substrate; and
forming a molded-in flange at a periphery of the body portion by injecting the resin into the mold adjacent to the first surface of the cover stock material to provide the substrate, the molded-in flange includes the cover stock material integrally molded with and substantially concealing the substrate,
wherein the molded-in flange includes a portion extending substantially parallel to the body portion of the component.

2. The method of claim 1 wherein the second mold section is a stationary mold section.

3. The method of claim 2 wherein the cover stock material is provided in the first mold section.

4. The method of claim 1 wherein the mold further includes a lifter mechanism having a first surface, the lifter mechanism is provided at the second mold section.

5. The method of claim 4 wherein the step of forming the substrate comprises injecting the resin into a cavity defined by the first surface of the cover stock material, the second mold section, the third mold section, and the first surface of the lifter mechanism.

6. The method of claim 5 wherein the extension is at least partially formed on the first surface of the lifter mechanism.

7. The method of claim 1 wherein the molded-in flange extends continuously along at least one side of the body portion of the component.

8. The method of claim 7 wherein the molded-in flange further includes a second portion extending substantially perpendicular to the body portion of the component.

9. The method of claim 1 wherein the cover stock material is formed of more than one material.

10. The method of claim 1 wherein the component is an interior door panel for a vehicle.

11. A trim panel for use in a vehicle, the trim panel comprising:
a one-piece molded member having a body portion and an extension, the extension is provided at a periphery of the body portion for securing the trim panel to the vehicle, the extension including a first portion extending substantially perpendicular to the body portion and a second portion extending substantially parallel to the body portion, the extension is formed of a cover stock material and a substrate, the cover stock material substantially concealing the substrate at both the first portion and the second portion,
wherein the body portion and the extension are formed during the same molding operation wherein the cover stock material is positioned into a mold, the mold is reconfigured to bend an edge of the cover stock material inward, and a resin is injected into the mold to form the substrate.

12. The trim panel of claim 11 wherein the extension extends continuously along at least one side of the body portion.

13. The trim panel of claim 11 wherein the cover stock material is formed of more than one material.

14. The trim panel of claim 11 wherein the trim panel is an interior door panel for a vehicle.

15. A method of forming a component for a vehicle, the method comprising:
forming a substrate by injecting a resin into a mold having a first mold section and a second mold section, the substrate having an extension in an extended position;
providing a boundary between the extension and a body portion of the substrate for assisting in moving the extension between the extended position and a bent position;
subjecting the substrate to localized heating; and
bending the extension about the boundary until the bent position is achieved,
wherein the extension provides a,mechanism for securing the component to the vehicle.

16. The method of claim 15 further comprising the steps of coupling a cover stock material to the substrate for at least partially covering the extension and the body portion of the substrate.

17. The method of claim 15 wherein the boundary includes a recess.

18. The method of claim 17 wherein the recess is formed during the forming of the substrate.

19. The method of claim 17 wherein the recess is formed as a post-molding operation.

20. The method of claim 15 wherein after the component is formed the extension is configured as a downturn flange comprising a first portion extending substantially perpendicular to a body portion of the component and a second portion extending substantially parallel to the body portion of the component.
